(19) United States
(12) Patent Application Publication
(10) Pub. No.: US 2015/0053056 A1
(43) Pub. Date: Feb. 26, 2015

(54) Cutting board systems and methods

(71) Applicant: Ligia Nagy Ramos, Frisco, TX (US)

(72) Inventor: Ligia Nagy Ramos, Frisco, TX (US)

(21) Appl. No.: 13/999,520

(22) Filed: Mar. 6, 2014

Related U.S. Application Data
(60) Provisional application No. 61/851,316, filed on Mar. 6, 2013.

(51) Int. Cl. A47J 47/00

(52) U.S. Cl. CPC A47J 47/005
USPC 83/39; 269/289 R; 269/9

(57) ABSTRACT

A cutting board includes a cutting portion for cutting material thereon. The cutting board also includes one or more extensions extending from the cutting portion. At least one of the one or more extensions is operable to identify a type of food to be used with the cutting board. Systems and methods are also provided.

### CROSS REFERENCE TO RELATED APPLICATIONS

This application claims priority from U.S. provisional patent application Ser. No. 61/851,316, filed Mar. 6, 2013, which is incorporated by reference herein in its entirety.

### TECHNICAL FIELD

This application relates generally to cutting boards and more particularly cutting board systems and methods.

### BACKGROUND

The use of cutting boards for cutting meats, vegetables and other food stuffs in the kitchen is well-known. The use of a single cutting surface can lead to cross contamination of undesirable bacteria, flavors and other contaminants from one food to another. It is important while preparing foods to separate different types of meats, such as chicken, beef, fish, etc. while cutting and/or cleaning, so that each of the meats is not cross contaminated by cutting different meats on the same board surface. Vegetables and fruits may also be contaminated by bacteria, flavors and other contaminants from meat(s) or other vegetables and fruits. Having to stop and clean the cutting surface after each food cutting event is time consuming and may interrupt the timely cooking process when certain foods have to be prepared at certain times while cooking. Therefore, there exists a significant need for improved cutting board systems and methods.

### SUMMARY

According to an illustrative embodiment, a cutting board comprises a planar portion for cutting material thereon; and one or more extensions extending from the planar portion, at least one of the one or more extensions operable to identify a type of food to be used with the cutting board.

According to another illustrative embodiment, a cutting board system comprises a first cutting board comprising: a planar portion for cutting material thereon; and one or more extensions extending from the planar portion, at least one of the one or more extensions operable to identify a first type of food to be used with the first cutting board; a second cutting board comprising: a planar portion for cutting material thereon; and one or more extensions extending from the planar portion, at least one of the one or more extensions operable to identify a second type of food to be used with the second cutting board, wherein the first type of food is different from the second type of food.

In another embodiment, a method for cutting foods comprises providing a first cutting board and cutting a first food thereon; and providing a second cutting board and cutting a second food thereon, wherein the first food is different from the second food.

### BRIEF DESCRIPTION OF THE DRAWINGS

FIG. 1 shows a first illustrative cutting board;

FIG. 2 shows a second illustrative cutting board;

FIG. 3 shows an illustrative cutting board system; and

FIG. 4 shows an illustrative cutting board with a holder.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims. Further, unless otherwise indicated, as used herein, “or” does not require mutual exclusivity.

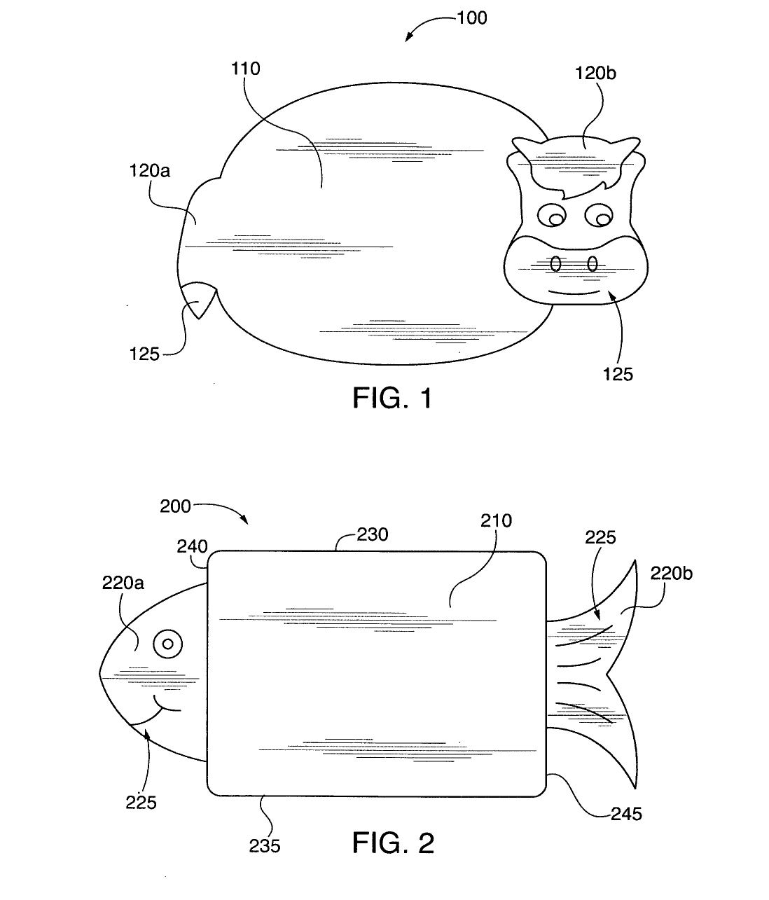

Referring now to FIG. 1, an illustrative cutting board 100 is shown. The cutting board includes a portion 110 for cutting material thereon. In one embodiment, the portion 110 for cutting material thereon is planar. However, it will be appreciated that any other configuration may be employed and remain within the scope of the present disclosure. For example, and without limitation, a cutting board may include a bowl-like cutting portion similar to that of an Alaskan Ulu cutting board and remain within the scope of the present disclosure.

The cutting board 100 also includes one or more extensions 120a-120b (collectively 120) coupled to the cutting portion 110. The extension(s) 120 are operable to identify a type of food to be used with the cutting board. As used herein, the term “coupled” includes coupling via a separate object and includes direct coupling. The term “coupled” also encompasses two or more components that are continuous with one another by virtue of each of the components being formed from the same piece of material. Also, the term “coupled” may include chemical, such as via a chemical bond, mechanical, thermal, or electrical coupling.

The extension(s) 120 may identify the type of food to be used with the cutting board 100 in a variety of ways. In the illustrative embodiment, the extension(s) 120 are partially shaped to identify the type of food to be used with the cutting board 100. For example, extension 120a is partially shaped as a cow's tail and extension 120b is partially shaped as a cow's head to identify beef as the food to be used with the cutting board 100. Additionally, each extension 120 may include graphical indicia 125 thereon to further identify the food to be used with the cutting board 100. The graphical indicia 125 may be formed in, disposed on, embedded in or otherwise coupled to the extension(s) 120. Additionally, the graphical indicia 125 may also extend over at least a portion of the cutting portion 110.

While the illustrative embodiment employs both extension(s) 120 shaped to identify the food to be used with the board as well as graphical indicia 125, it will be appreciated that a cutting board having only extension(s) shaped as food to be used with the cutting board is contemplated and within the scope of the present disclosure. Likewise, a cutting board having extensions only with graphical indicia thereon to identify the food to be used with the board is contemplated and considered within the scope of the present disclosure. Further, any suitable arrangement for identifying foods to be used with the cutting board are contemplated herein and considered within the scope of the present disclosure. Additionally, in one embodiment, the extension(s) may also be used as handles such that the cutting board may also be used as a serving tray.

The extension(s) 120 may identify any suitable food to be used with the cutting board 100. For example, and without limitation, beef, poultry, fish, pork, cheese, fruits, vegetables, or any other food or type of food. Also, the extension(s) 120 may identify particularly pungent foods where it may be desirable to keep such foods separated from other foods; for example, and without limitation, onion, garlic, salmon, certain cheeses, etc. The extension(s) 120 may also identify foods associated with certain holidays (e.g. turkey).

Referring now to FIG. 2, an alternative cutting board 200 is shown. The cutting board. 200 is analogous in most respects to the cutting board 100 of FIG. 1 and a correlation of parts is generally indicated in this embodiment by indexing the numerals in FIG. 1 by 100. The cutting board 200 includes a first edge 230, a second edge 235, a third edge 240 and a fourth edge 245. The first and second edges 230, 235 are parallel with one another, and the third and fourth edges 240, 245 are parallel with one another and perpendicular with the first and second edges 230, 235. In one embodiment, the edges 230-245 define the outer perimeter of the cutting portion 210, however, it will be appreciated that the cutting area may be more central to cutting board and the cutting area not necessarily defined by the edges—for example, a cutting board may include a bowl-like cutting area similar to that of an Alaskan Ulu cutting board and remain within the scope of the present disclosure. Also, in one embodiment, at least one of the first and second edges 230, 235 is substantially straight, which may be beneficial for storing the cutting board 200 in a cutting board holder or in an otherwise generally horizontal fashion. One or more extensions 220a-220b extend from one or both of the third and fourth edges 240, 245 and may be shaped as previously described with respect to FIG. 1. Also, while the illustrative embodiment shows the extensions extending from discernible third and fourth edges, it will be appreciated that extensions sized such that such third and fourth edges are not discernible are expressly contemplated and considered within the scope of the present disclosure. Also, while the illustrative embodiment shows four straight edges, it will be appreciated that any number of straight edges may be employed and remain within the scope of the present disclosure and that the present disclosure is in no way limited to only four straight edges or any straight edges.

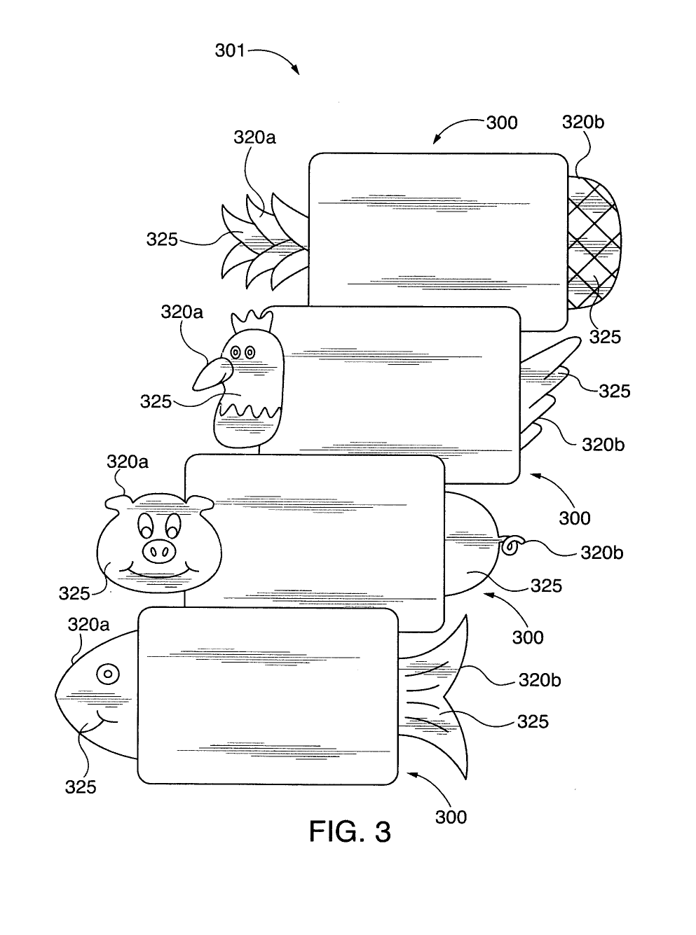

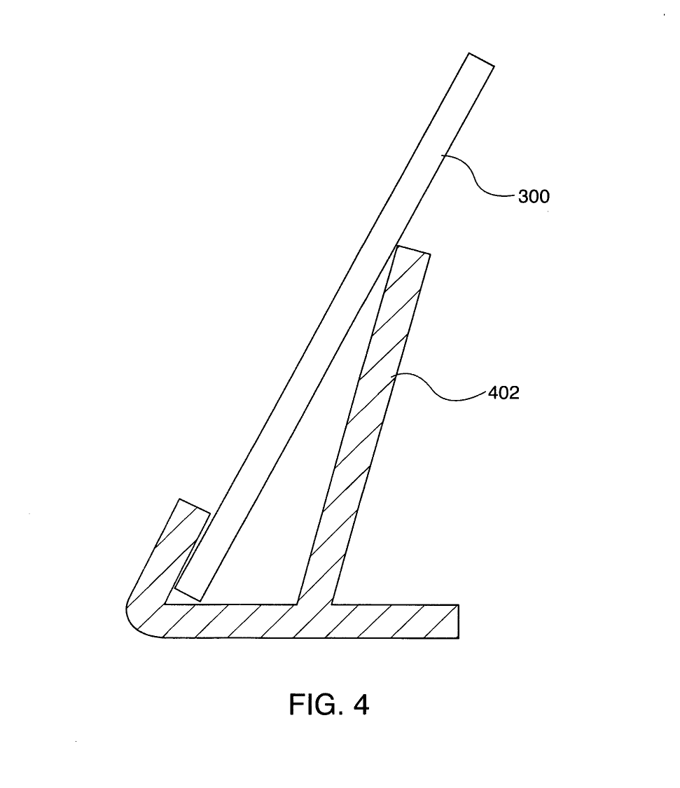

FIG. 3 illustrates a cutting board system 301. The cutting board system 301 includes a plurality of cutting boards 300 where each cutting board 300 is associated with a different type of food. Each cutting board 300 is analogous in most respects to the cutting board 100 of FIG. 1 and a correlation of parts is generally indicated in this embodiment by indexing the numerals in FIG. 1 by 200. While four cutting boards 300 are illustrated, it will be appreciated a system may include any suitable number of cutting boards associated with any number of any suitable foods and remain within the scope of the present disclosure. Also, while each cutting board 300 is shown as having the extensions 320 shaped as a food associated with the board as well as graphical indica 325 also associated with the food, it will be appreciated that each board may employ only one of the shaped extensions or the graphical indicia and remain within the scope of the present disclosure. In other words, it is not necessary that each board identify the food associated therewith in the exact same manner as other boards in the system. Also, in one embodiment, as shown in FIG. 4, a system 301 may include a holder 402 capable of holding one or more of the cutting boards 300 such that one or more of the boards may be stored by the holder 402 and/or displayed by the holder 402.

In use, a user may select a first cutting board and cut a first food associate with the board thereon. The first board may be placed aside and a second cutting board selected. A second food associated with the second board may be selected and cut on the second board. The user may continue this process in any suitable order and with any suitable number of boards and suitable types of food.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A cutting board comprising:
a cutting portion for cutting material thereon; and
one or more extensions extending from the cutting portion, at least one of the one or more extensions operable to identify a type of food to be used with the cutting board.

2. The cutting board of claim 1 wherein at least one of the one or more extensions is at least partially shaped so as to identify the type of food to be used with the cutting board.

3. The cutting board of claim 1 wherein at least one of the one or more extensions includes graphical indicia to identify the type of food to be used with the cutting board.

4. The cutting board of claim 2 wherein the graphical indicia extends partially into the cutting portion.

5. The cutting board of claim 1 wherein the one or more extensions are integral with the cutting portion.

6. The cutting board of claim 1 wherein the one or more extensions identify at least one of beef, seafood, poultry, pork, fruits, and vegetables.

7. A cutting board system comprising:
a first cutting board comprising:
a cutting portion for cutting material thereon; and
one or more extensions extending from the cutting portion, at least one of the one or more extensions operable to identify a first type of food to be used with the first cutting board;
a second cutting board comprising:
a cutting portion for cutting material thereon; and
one or more extensions extending from the cutting portion, at least one of the one or more extensions operable to identify a second type of food to be used with the second cutting board, wherein the first type of food is different from the second type of food.

8. The cutting board system of claim 7 wherein at least one of the one or more extensions of the first cutting board is at least partially shaped so as to identify the first type of food.

9. The cutting board system of claim 8 wherein at least one of the one or more extensions of the first cutting board includes graphical indicia to identify the first type of food.

10. The cutting board system of claim 8 wherein at least one of the one or more extensions of the second cutting board is at least partially shaped so as to identify the second type of food.

11. The cutting board system of claim 10 wherein at least one of the one or more extensions of the second cutting board includes graphical indicia to identify the second type of food.

12. The cutting board system of claim 7 wherein the one or more extensions of the first cutting board identify at least one of beef, seafood, poultry, pork, fruits, and vegetables.

13. The cutting board system of claim 7 wherein the one or more extensions of the second cutting board identify at least one of beef, seafood, poultry, pork, fruits, and vegetables.

14. A method for cutting foods comprising:
providing a first cutting board and cutting a first food thereon; and
providing a second cutting board and cutting a second food thereon, wherein the first food is different from the second food.

15. The method of claim 14 wherein the first cutting board comprises a cutting portion for cutting material thereon; and one or more extensions extending from the cutting portion, at least one of the one or more extensions operable to identify a first type of food to be used with the first cutting board.

16. The method of claim 15 wherein the second cutting board comprises a cutting portion for cutting material thereon; and one or more extensions extending from the cutting portion, at least one of the one or more extensions operable to identify a second type of food to be used with the second cutting board, wherein the first type of food is different from the second type of food.

17. The method of claim 16 wherein at least one of the one or more extensions of at least one of the first and second cutting boards is at least partially shaped so as to identify the corresponding first or second food.

18. The method of claim 16 wherein at at least one of the one or more extensions of at least one of the first and second cutting boards includes graphical indicia to identify the corresponding first or second food.
